(19) United States
(12) Patent Application Publication
(10) Pub. No.: US 2009/0201774 A1
(43) Pub. Date: Aug. 13, 2009

(54) CONTACT COMPONENT AND TIMEPIECE

(75) Inventors: Akihiro FUJIMORI, Suwa (JP); Masami MURAI, Shiojiri (JP); Susumu ARAI, Nagano (JP)

Correspondence Address: GLOBAL IP COUNSELORS, LLP, 1233 20TH STREET, NW, SUITE 700, WASHINGTON, DC, 20036-2680, US

(73) Assignees: SEIKO EPSON CORPORATION, Tokyo (JP); SHINSHU UNIVERSITY, Nagano (JP)

(21) Appl. No.: 12/364,914

(22) Filed: Feb. 3, 2009

(30) Foreign Application Priority Data
Feb. 7, 2008 (JP) 2008-027549
Aug. 8, 2008 (JP) 2008-206069

(51) Int. Cl. G04B 13/00

(52) U.S. Cl. 368/320

(57) ABSTRACT

A contact component, including: a sliding part that contacts with an other component and slides on the other component, or a switching part at which a contact state with the other component is switched, in which a composite plating including a metal plating and graphite particles is formed on the sliding part or the switching part.

The entire disclosure of Japanese Patent Application No. 2008-027549, filed Feb. 7, 2008 and No. 2008-206069, filed Aug. 8, 2008 is expressly incorporated by reference herein.

### BACKGROUND

1. Technical Field

The present invention relates to a contact component having a sliding part or a switching part and a timepiece having the contact component.

2. Related Art

Timepieces use contact components that have sliding parts that slide in contact with other components (see, Document 1: JP-A-2003-156575, for instance). Examples of such sliding parts include pinions and pivots of gear wheels in a wheel train. Additionally, timepieces also use contact components having switching parts that change the contact state with other components as a result of operation on a winding crown and the like. Examples of the switching parts include trigger pieces and yokes in a hand adjustment mechanism engaging with each other.

The sliding parts and switching parts are usually lubricated to keep operation accuracy and ensure long-term reliability. However, oil is degraded during a long-term use and use in a low-temperature environment, which increases friction resistance. Further, the switching parts, pivots of gear wheels rotating with a low speed and high torque may be scraped as a result of a point-contact with the other components, the scraped piece increasing friction resistance.

Since such increase in the friction resistance may reduce operation accuracy or shorten battery lifetime, it is proposed in the Document 1 that a chemical conversion treatment film and a coating that covers the chemical conversion treatment film to exhibit lubricity are provided on the sliding parts. The coating includes solid lubricating particles, a binder and an anti-corrosion agent. The document 1 lists fluorinated resin particles, graphite fluoride and boron nitride as the solid lubricating particles, organic resin as the binder and pigment as the anti-corrosion agent. The chemical conversion treatment film is provided to enhance adhesion between the solid lubricating film and the component surface, which is typically provided by zinc phosphate coating, manganese phosphate coating or iron phosphate coating.

Incidentally, in order to improve the appearance of the timepiece components, after nickel-plating the entire timepiece component, only the sliding parts are polished to remove the nickel-plating thereon and the chemical conversion treatment film and the coating are provided on the part at which the basis metal of the component is exposed.

However, since the coating containing resin material as shown in the Document 1 is low in durability, the coating is scraped off after long-term use. Further, since the coating containing resin material has a tendency to be peeled off, the coating is also peeled off after long-term use even when the adhesion of the coating is enhanced by the chemical conversion treatment film. In short, it is difficult to keep the coating that exhibits sufficient lubricity for a long time. Accordingly, it is required to prevent wear of the components by periodic cleaning after disassembly, and lubrication.

In addition to the above, since both the chemical conversion treatment film and the coating have to be provided on the surface of the component in the Document 1, complicated manufacturing process is required, thus increasing the production cost.

### SUMMARY

An object of the invention is to provide a contact component of which wear resistance is greatly improved and a timepiece having the contact component.

The inventors of the present application conducted vigorous research on the solution of the above problems including formation of a highly rigid coating on contact components by electroless nickel plating and thermal treatment. As a result, the inventors have found that a coating having significantly improved wear resistance can be easily formed on contact components by metal plating process mixed with graphite particles.

A contact component according to an aspect of the invention includes: a sliding part that contacts with an other component and slides on the other component, or a switching part at which a contact state with the other component is switched, in which a composite plating including a metal plating and graphite particles is formed on the sliding part or the switching part.

According to the above aspect of the invention, excellent lubricity of graphite can be obtained since the graphite particles are exposed on the contact surface of the sliding part and the switching part touching the other component. In addition, since the graphite particles are deformed as a result of contact between the components to be adhered on the contact surface of the sliding part and the switching part, the lubricity of the graphite can be exhibited for a long time. Consequently, excellent wear resistance that cannot be obtained by providing a resin coating or by simply providing a highly rigid coating can be achieved.

Further, complicated manufacturing steps are not necessary in the above aspect of the invention since it is only necessary to mix the graphite particles in a plating bath before the component is subjected to a plating process.

Thus, the wear resistance of the contact component can be considerably improved with a low cost.

Incidentally, the metal plating is exposed on the surface of the coating of the composite plating not covered by the graphite particles. Accordingly, even when the composite plating is formed on the entire surface of the contact component, the decorative effect of the portion other than the sliding part and the switching part is not impaired.

In the above aspect of the invention, the component is not necessarily lubricated because the component itself exhibits excellent wear resistance. However, wear resistance can be further improved by lubricating the component. When the component is lubricated, since oil is not easily run off on account of the exposed graphite particles on the surface of the coating, a less number of disassembly cleaning and lubrication is necessary.

In the contact component of the above aspect, it is preferable that the composite plating includes a coating including a metal plating and a part of the graphite particles that is buried in the metal plating; and a graphite-exposed portion including a part of the graphite particles that is exposed from the coating, and the graphite-exposed portion is roll-pressed along the coating.

According to the above aspect, since the graphite-exposed portion is roll-pressed to assume a layer structure, and the components are slid in a slide contact state on the intervening layer-shaped graphite-exposed portion, the lubricity of graphite can be sufficiently exhibited. Thus, wear resistance can be further improved. Further, since the graphite-exposed portion is roll-pressed to be adhered on the coating, the graphite particles are not easily scraped, so that the layer-shaped structure of the graphite-exposed portion can be maintained for a long time.

In addition, when there are fine asperities on the surface of the coating on account of irregularities on the surface of the base material and the like, the roll-pressed graphite particles cover the asperities to smooth the contact surface. The wear resistance can also be improved in this regard.

Incidentally, the layer-shaped graphite-exposed portion will be sometimes referred to as a graphite layer.

In the contact component of the above aspect, it is preferable that the composite plating includes a coating including a metal plating and a part of the graphite particles buried in the metal plating; and a graphite-exposed portion including a part of the graphite particles exposed from the coating, and the graphite-exposed portion is roll-pressed along the coating when being contacted with the other component.

According to the above arrangement, since the graphite-exposed portion is roll-pressed as a result of the contact with the other component, the same effects as the above can be obtained. Since the graphite-exposed portion is roll-pressed when being in contact with the other component, it is not necessary to roll-press the graphite-exposed portion before using the contact component.

In the contact component of the above aspect of the invention, the particle size of the graphite particles is preferably 100 nm or greater and 500 nm or smaller.

According to the above aspect, the particle size of the graphite particles further ensures the formation of the graphite layer by a series of continuous plurality of the graphite particles as a result of contact with the other component.

When the particle size is less than 100 nm, the graphite particles are easily scraped as a result of the contact against the other component to form a rolling contact state, where wear resistance is inferior to a slide contact state in which the lubricity of graphite can be sufficiently exhibited. On the other hand, when the particle size is larger than 500 nm, though the wear resistance can be improved, the improvement in the wear resistance is not proportional to the amount of graphite. Accordingly, the particle size of the graphite is preferably 100 nm or larger and 500 nm or smaller.

Further, since the above range of particle size offers excellent dispersibility, the amount of the graphite particles incorporated into the metal plating during the plating process, i.e. the content of graphite in the metal plating is increased. Consequently, the amount of graphite exposed on the surface of the coating of the composite plating is increased, thus improving the lubricity. In sum, the wear resistance can be further improved the formation of the graphite layer without scraping the graphite particles and the increase in the graphite content by ensuring excellent dispersibility.

In the contact component of the above aspect of the invention, the thickness of the composite plating is preferably 0.1 μm or more and 10 μm or less.

According to the above arrangement, since the composite plating is thin, the thickness fluctuation of the composite plating can be reduced, so that dimension accuracy required for precision parts can be ensured.

When the thickness of the composite plating is less than 0.1 μm, since the graphite particles are not sufficiently incorporated into the metal plating, improvement in the wear resistance is not expected.

In contrast, when the thickness of the composite plating exceeds 10 μm, since the variation in thickness is magnified, it is difficult to maintain the dimension accuracy required for precision parts. In addition, wear resistance proportional to the incorporated amount of the graphite particles cannot be obtained (saturation of friction reduction). Accordingly, the preferable range of the thickness of the composite plating is 0.1 μm or more and 10 μm or less.

The thickness of the composite plating refers to the thickness of the entirety of the composite plating. When the graphite particles are protruded from the surface of the metal plating, the thickness of the composite plating means the sum of the thickness of the metal plating and the dimension of the graphite particles protruded from the surface of the metal plating. Incidentally, when the graphite layer is formed along the surface of the metal plating, the thickness of the composite plating refers to the sum of the thickness of the metal plating and the thickness of the graphite layer. The thickness of the composite plating may sometimes be referred to as “film thickness” of the composite plating.

In the contact component of the above aspect of the invention, the content of the graphite particles in the metal plating is preferably 0.1 mass % or more and 5 mass % or less.

According to the above arrangement, since a large amount of the graphite particles is contained, a composite plating having sufficient lubricity can be formed with a small film thickness.

When the content of graphite is less than 0.1 mass %, since the amount of graphite exposed on the surface of the composite plating coating is small, improvement of wear resistance is hardly expected. In contrast, when the content of the graphite exceeds 5 mass %, in addition to saturation of friction reduction effect, plating failure and plating crack are likely to occur on account of an increased amount of dispersant. Accordingly, the content of the graphite particles in the metal plating is preferably 0.1 mass % or more and 5 mass % or less.

In the contact piece of the above aspect of the invention, the composite plating is preferably formed on an entire surface of the contact component or on a contact portion against the other component.

As described above, since the metal plating is exposed on the surface of the composite plating coating not covered by the graphite particles, decorative effect of the contact component is not impaired even when the composite plating is formed on the entire surface of the contact component. Accordingly, by forming the composite plating coating on the entire surface of the contact component, contact components having excellent appearance and wear resistance can be easily obtained without separately plating portions other than the portion that contacts with the other component, such as sliding parts and switching parts.

When the composite plating is formed only on the contact portion with the other component, the amount of graphite and dispersant can be reduced.

In the contact component of the above aspect of the invention, the metal plating is preferably nickel plating.

According to the above arrangement, composite plating having great corrosion resistance and excellent appearance as well as excellent wear resistance can be provided by the combination of nickel and graphite.

In the contact component of the above aspect of the invention, the composite plating is preferably formed by an electroplating process.

According to the above arrangement, since the surface of the metal plating becomes smooth by the electroplating process so that the lubricity of the metal plating coating is improved, the wear resistance can be further improved.

In the contact component of the above aspect of the invention, the composite plating is preferably formed by an electroless plating process.

According to the above arrangement, harder metal plating coating than that in the electroplating process can be formed by subjecting the composite plating to thermal treatment and the like after the electroless plating process, so that wear resistance can be improved. Further, the electroless plating process can easily form a coating of a uniform thickness even on an irregular part of the contact component or a part of the contact component having large curvature, so that high wear resistance can be stably obtained.

In the contact component of the above aspect of the invention, the sliding part is preferably a pivot or a pinion of a timepiece gear train component.

According to the above arrangement, since the composite plating is formed on the pivot or pinion that is easily worn by a high-speed or high-torque rotation, the improvement in wear resistance can be suitably exhibited.

In the contact component of the above aspect of the invention, the switching part preferably contacts the other component while being pressed by a spring force.

According to the above arrangement, since the composite plating is formed on the switching part that is easily worn by the great load applied when contact state is switched while being pressed, the improvement in wear resistance can be suitably exhibited.

A timepiece according to another aspect of the invention includes the above contact component.

According to the above aspect of the invention, since the above-described contact component is provided, the same functions and effects as described above can be obtained.

According to the above aspect of the invention, a contact component having considerably improved wear resistance can be provided without requiring complicated process.

### BRIEF DESCRIPTION OF THE DRAWINGS

The invention will be described with reference to the accompanying drawings, wherein like numbers reference like elements.

FIG. 1 is a plan view showing a movement of a timepiece according to a first exemplary embodiment of the invention.

FIG. 2 is a cross section of the movement.

FIG. 3 is an enlarged view showing a sliding part of a rotor of a generator.

FIG. 4 is a schematic enlarged illustration of a primary part of FIG. 3.

FIG. 5 is a schematic illustration showing a state of a composite plating after experiencing a slide movement against the other component.

FIG. 6 is a graph showing results of wear tests of the composite plating.

FIG. 7 is a chart indicating good and bad conditions of the composite plating along with various parameters.

FIG. 8 is a 40-fold magnified photograph of friction trace after the wear tests (particle size approximately 200 nm).

FIG. 9 is another 40-fold magnified photograph of friction trace after the wear tests (particle size approximately 20 nm).

FIG. 10 is a 1000-fold magnified photograph of a sample 2 after the composite plating.

FIG. 11 is another 1000-fold magnified photograph of the sample 2 on which the composite plating is formed after experiencing a friction and wear tests.

FIG. 12 shows both surface photograph after the friction and wear tests and surface roughness data of a worn trace.

FIG. 13 is an illustration showing a hand adjustment mechanism according to a second exemplary embodiment of the invention, where a winding shaft is pushed in.

FIG. 14 is an illustration showing the hand adjustment mechanism, in which the winding shaft is pulled out.

FIG. 15 is a cross section taken along XV-XV line in FIG. 13.

### DESCRIPTION OF EXEMPLARY EMBODIMENT(S)

Embodiments of the invention will be described below with reference to attached drawings.

### First Embodiment

A first exemplary embodiment is an electronic timepiece having a generator. In this exemplary embodiment, a contact component having a sliding part is exemplified by a rotor of the generator.

### 1. Arrangement of Electronic Timepiece

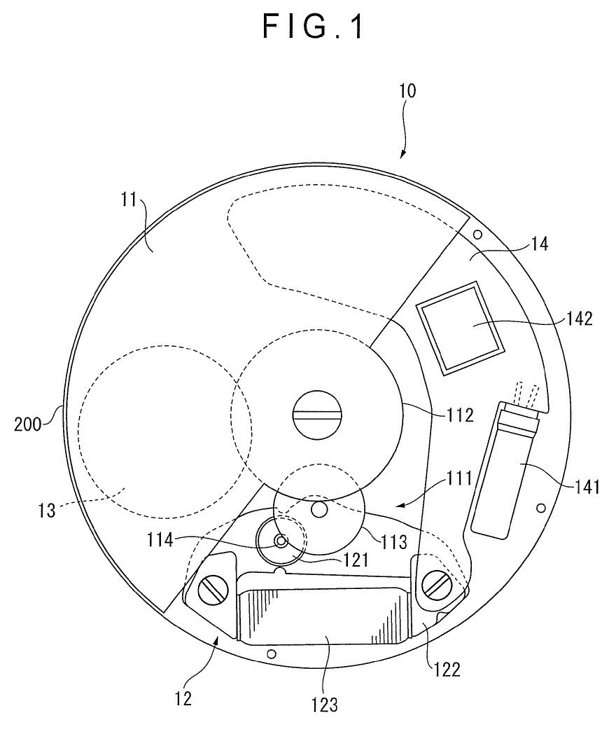

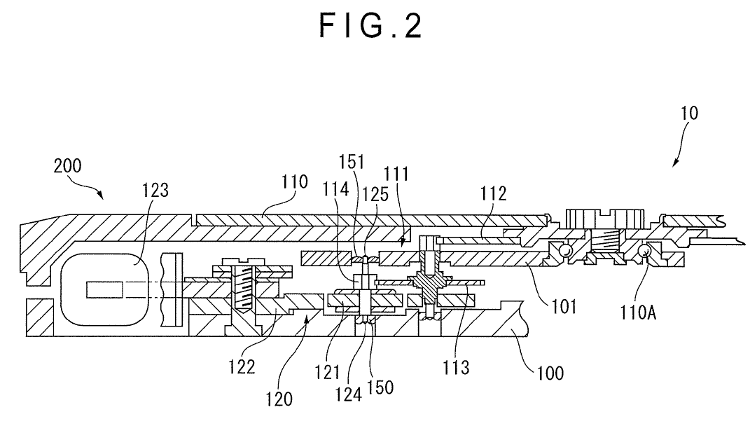

FIG. 1 is a plan view showing a movement 10 of a wristwatch according to the exemplary embodiment. FIG. 2 is a cross section of the movement 10.

The movement 10 includes: an oscillating weight 11; a speed-increasing wheel train 111 that accelerates and transfers rotations of the oscillating weight 11; a generator 12 that produces electrical power from the rotary force of the oscillating weight 11; a secondary battery 13 that stores the electrical power generated by the generator 12; a circuit board 14 that is driven by the electrical power generated by the generator 12 or the electrical power stored in the secondary battery 13; and a step motor (not shown) that drives hands such as an hour hand and a minute hand.

The oscillating weight 11 is a substantially semicircular member with its center of gravity eccentric to the axis of rotation, which is supported rotatably to a base plate 100 by an intervening ball bearing 110A (FIG. 2).

The speed-increasing wheel train 111 includes a gear wheel 112 fixed to the oscillating weight 11, an intermediate wheel 113 that meshes with the gear wheel 112 and a rotor pinion 114 that meshes with the intermediate wheel 113.

The generator 12 includes a rotor 121 (the contact component having a sliding part), a stator 122 and a coil 123. The rotor pinion 114 is fixed on the rotor 121. The rotary motion of the oscillating weight 11 is accelerated through the gear wheel 112, the intermediate wheel 113 and the rotor pinion 114 to rotate the rotor 121 at a high speed.

The circuit board 14 includes a crystal oscillator 141, a control chip 142 and the like. The control chip 142 includes a frequency divider circuit that divides a reference clock of the crystal oscillator 141, a timer circuit that counts the reference clock to measure the time, and a controller circuit that controls the step motor in accordance with the signal from the timer circuit.

### 2. Arrangement of Rotor with Sliding Part

As shown in FIG. 2, the rotor 121 is supported between the base plate 100 and a gear train holder 101 and is provided with a bottom pivot 124 and an upper pivot 125.

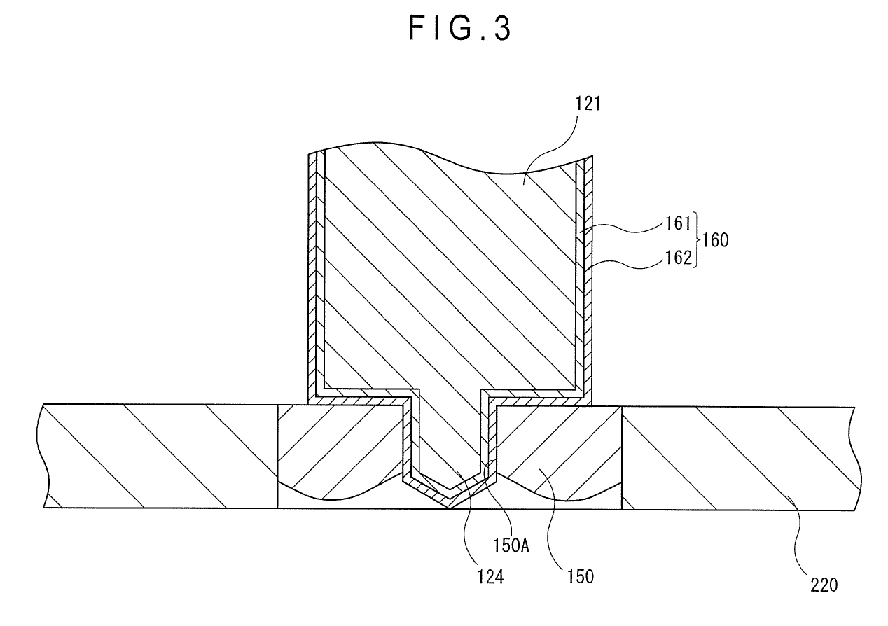

FIG. 3 shows a lower part of the rotor 121. The bottom pivot 124 of the rotor 121 is inserted to a jewel 150 such as a ruby having a pivot hole 150A at the center thereof.

The sliding part is the contact portions of the rotor 121 against the jewel 150 and a jewel 151 (FIG. 2). A composite plating 160 is applied at least on a part of the rotor 121 covering the sliding part. Though the composite plating 160 is applied on the entire surface of the rotor 121 in this exemplary embodiment, the composite plating 160 may be applied solely on the sliding part.

### 3. Arrangement of Composite Plating

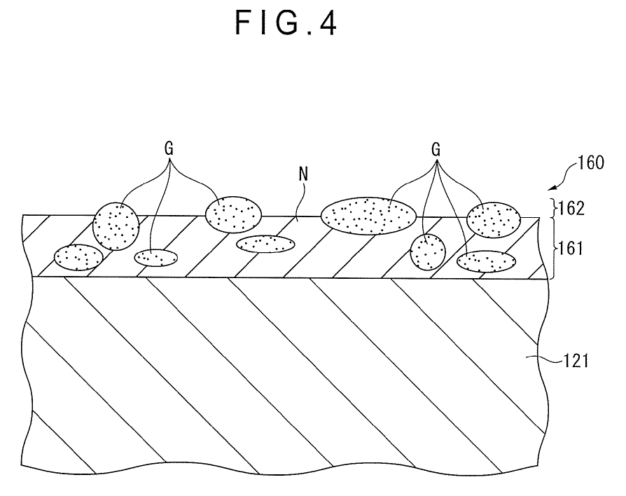

FIG. 4 is a schematic enlarged illustration of a primary part of FIG. 3. The composite plating 160 is formed by mixing graphite particles G into nickel plating N (metal plating). In the exemplary embodiment, the metal plating of the composite plating is nickel plating for the purpose of rust prevention. However, zinc plating, other metal plating and alloy plating may alternatively be used.

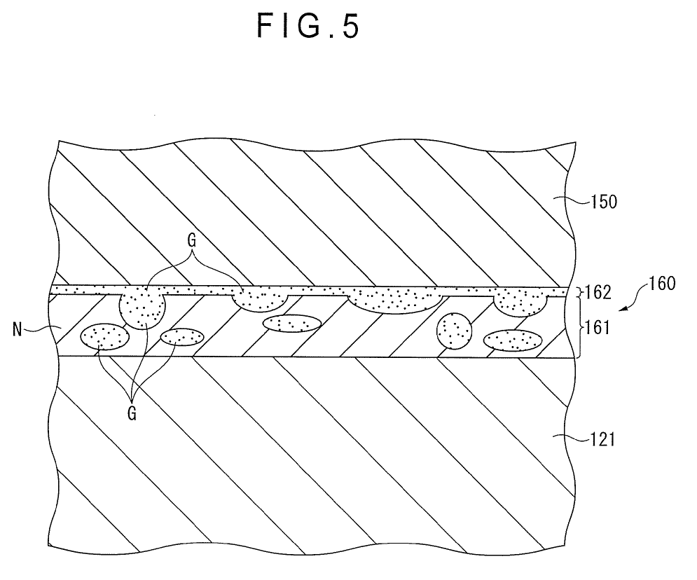

Incidentally, in FIG. 4 and below-described FIG. 5, the size of the graphite particles G is exaggerated relative to the thickness of the nickel plating N for the purpose of assisting understandings of the structure.

Incidentally, FIG. 4 shows the rotor 121 not having been slid against the jewel 150 as the other component.

The composite plating 160 of the exemplary embodiment is formed by an electroplating process in which the rotor 121 is immersed in an electroplating nickel bath mixed with the graphite particles G and voltage is applied with the rotor 121 acting as a negative electrode. Nickel and graphite are codeposited on the surface of the rotor 121 by electrolysis. Incidentally, the graphite particles G are dispersed in the plating bath by mixing a dispersant such as a polyacrylate in this exemplary embodiment. In the plating bath, the graphite particles G near the surface of the rotor 121 are drawn by nickel deposited on the surface of the rotor 121 to be captured in the nickel plating N so that the graphite particles are substantially uniformly dispersed in the nickel plating N.

Each of the graphite particles G is entirely or partially buried in the nickel plating N. Specifically, the graphite particles G located near the surface of the nickel plating N are partially buried in the nickel plating N to expose the residual part thereof from the nickel plating N.

The particle size of the graphite particles G is preferably 100 nm or larger and 500 nm or smaller. More preferably, the particle size is 200 nm or larger and 300 nm or smaller. Since the size of the graphite particles is thus large, the graphite particles G exhibit excellent dispersibility. Accordingly, a sufficient amount of the graphite particles G can be easily incorporated into the nickel plating N even when the film thickness is small. However, when the size of the graphite particles G exceeds 500 nm, the dispersibility may be deteriorated.

Thus, the composite plating 160 is provided under a film-forming condition for obtaining film thickness of 0.1 μm or larger and 10 μm or smaller. Consequently, the content of the graphite particles G relative to the nickel plating N becomes 0.1 mass % or more and 5 mass % or less.

As a result, the composite plating 160 includes a coating 161 provided by the nickel plating N and the portion of the graphite particles G buried in the nickel plating N, and a graphite-exposed portion 162 provided by the portion of the graphite particles G exposed from the coating 161 without being buried in the nickel plating N. The film thickness of the composite plating 160 is the sum of the thickness of the coating 161 and the thickness of the graphite-exposed portion 162, which is 0.1 μm or larger and 10 μm or smaller.

FIG. 5 is a schematic illustration of the composite plating 160 after the rotor 121 and the jewel 150 slide relative to each other.

The graphite-exposed portion 162 is roll-pressed along the coating 161 as a result of the frictional slide motion against the jewel 150. Since the graphite particles G becomes continuous by the roll-pressing, the graphite-exposed portion 162 provides layer-shaped structure. The rotor 121 slides against the jewel 150 on the intervening layer-shaped graphite-exposed portion 162 in a “slide contact” manner. Accordingly, excellent lubricity of graphite is sufficiently exhibited.

Further, since the graphite particles G are roll-pressed to be adhered on the nickel plating N, the graphite layer (layer-shaped graphite-exposed portion 162) is maintained for a long time.

When there are fine asperities on the surface of the nickel plating N on account of irregularities on the surface of the base material of the rotor 121 and the like, the roll-pressed graphite particles G cover the asperities. Thus, the contact surface of the rotor 121 against the jewel 150 is smoothed to improve the lubricity.

Incidentally, the entirety of the nickel plating N may not be coated with the graphite particles G after roll-pressing the graphite particles G, but the nickel plating N may remain uncovered between the graphite particles G.

### 4. Wear Test

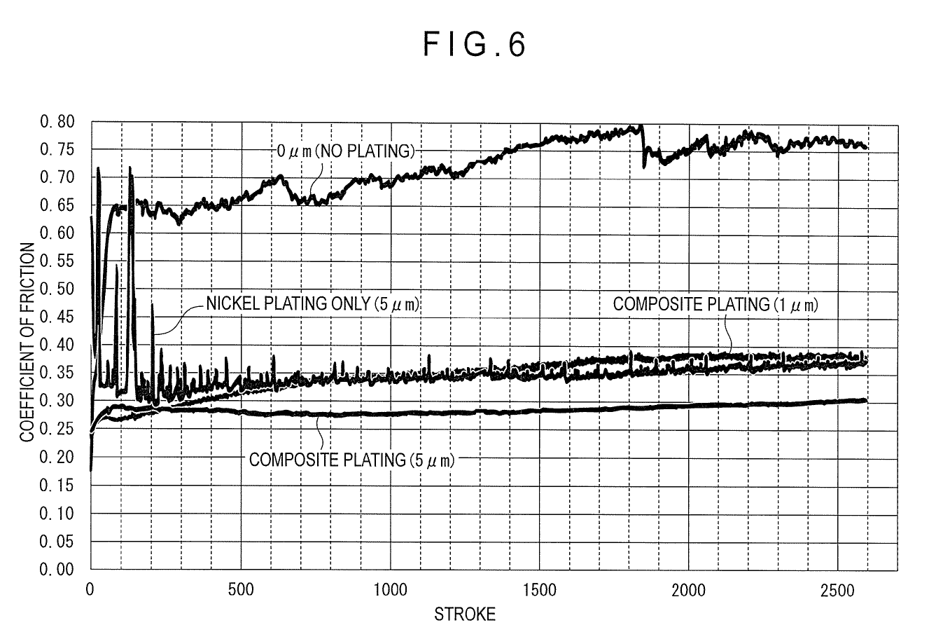

FIG. 6 shows results of wear tests of the composite plating 160. In this test, a reciprocating pivoted ball-on-plate friction and wear tester was used to measure the coefficient of friction between steel plates and alumina spheres (Al₂O₃) for test samples 1 to 4. The steel plate (high carbon steel member) had hardness Hv=700 and surface roughness (Ra)=5 nm. The alumina sphere had hardness Hv=1500. The size of the graphite particles was approximately 200 nm in this test.

Test sample 1: a steel plate on which composite plating of 1 μm film thickness was formed.

Test sample 2: a steel plate on which composite plating of 5 μm film thickness was formed.

(Comparative) test sample 3: a steel plate without plating.

(Comparative) test sample 4: a steel plate on which 5 μm thick nickel plating formed by electroplating was solely provided.

The test samples 3 and 4 were used for comparing with the results of the embodiment. The plating coating of the test sample 3 contained no graphite particles.

The test conditions of this test were a load of 100 g (90 kg/mm²), a stroke of 2 Hz (0.5 second/stroke), a stroke length of 10 mm and a total test time of 1400 seconds. This test is equivalent to a durability test of several months when converted to the sliding between the rotor 121 and the jewel 150.

Incidentally, the contact surface between the steel plate and the alumina spheres was not lubricated.

The coefficient of friction of the test sample 3 (a steel plate without plating) showed large value of approximately 0.63 to 0.80 and was unstable showing a great fluctuation. Further, the test sample 4 (nickel plating by electroplating process only) showed too much fluctuation of coefficient of friction especially during the initial stage of the test. The coefficient of friction of the test sample 4 showed a small value of around 0.35 during the middle period of the test. However, the coefficient of friction was greatly fluctuated all over from the start to the end of the test.

On the other hand, the test sample 1 (composite plating of 1 μm film thickness) showed stable and small (approximately 0.25 to 0.38) coefficient of friction from the start to the end of the test as compared to the test samples 3 and 4. The test sample 2 (composite plating of 5 μm film thickness) showed small more stable coefficient of friction as compared to the test sample 1 at a low level (approximately 0.25 to 0.30).

When the film thickness of the composite plating is greater than 10 μm, variation in the film thickness increases and it is difficult to maintain the dimensional precision required for a contact component. Further, even when the content of graphite is increased by providing a composite plating of film thickness greater than 10 μm, the coefficient of friction does not substantively decrease, which is not proportional to the graphite content. In other words, the friction reduction effect is “saturated”.

Accordingly, it is preferable that the film thickness of the composite plating is 0.1 μm or more in order to improve wear resistance and, at the same time, 10 μm or less.

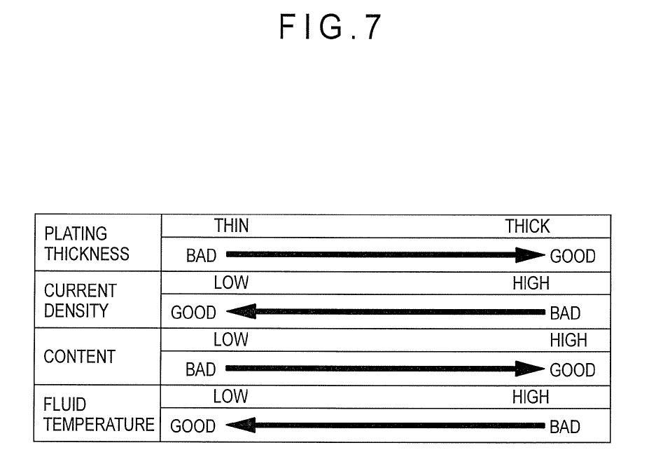

FIG. 7 shows good and bad conditions of the composite plating respectively in accordance with the film thickness of composite plating, current density, graphite content and liquid temperature of the plating bath. As shown in FIG. 7, the film thickness of the composite plating is preferably thick so as to incorporate sufficient amount of graphite into nickel plating. However, as discussed above, since a great increase in the film thickness accompanies variation in the film thickness and the reduction effect of the coefficient of friction is saturated, it is preferable that the upper limit is set at 10 μm.

On the other hand, in order to avoid plating burn, the current density is preferably low. More specifically, the current density is preferably 0.1 A/dm² or more and 30 A/dm² or less.

Further, more graphite content is preferable since it results in an increased amount of graphite exposed from the coating, thus improving lubricity. However, for fear of the above-discussed saturation of friction coefficient reduction effect and also for preventing plating failure on account of increased amount of necessary dispersant, the content of graphite in nickel plating is preferably 0.1 mass % or more to improve wear resistance and 5 mass % or less.

The liquid temperature of the plating bath is preferably low in order not to modify the dispersant, which is preferably 10° C. or higher and 40° C. or lower.

Next, the difference in the condition of the graphite layer due to the graphite particle size will be shown.

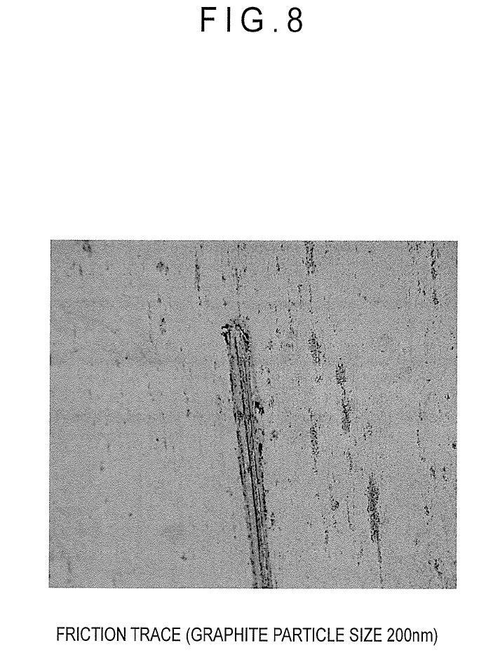

FIG. 8 is a photograph at a 40-fold magnification showing a friction trace of the test sample 2 after conducting the above friction and wear test. As described above, the size of the graphite particles of the test sample 1 was approximately 200 nm and the film thickness of the composite plating was 5 μm. As shown in FIG. 8, the graphite particles were roll-pressed as a result of slide movement against the alumina spheres to provide the graphite layer (layer-shaped graphite-exposed portion) 162 shown in a black streak. The graphite layer 162 was adhered onto the nickel plating N without producing scraped pieces. Accordingly, the graphite layer slides against other component in a slide contact manner, thus fully exhibiting lubricity of graphite.

Incidentally, since the graphite particles G were partially exposed from the coating 161 at portions not touched by the alumina spheres, decorative effect of the nickel plating was maintained.

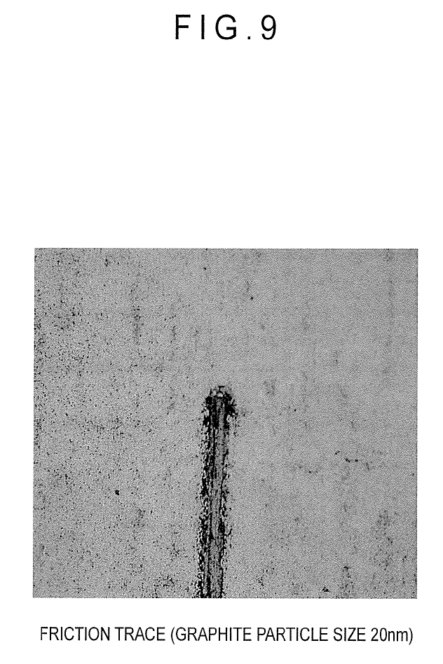

On the other hand, as a comparative example against FIG. 8, FIG. 9 is another photograph at a 40-fold magnification showing a friction trace on the above steel plate having composite plating (film thickness 5 μm) containing graphite particles of 20 nm after conducting the above friction and wear test. As shown in FIG. 9, the graphite particles are scraped at portions slid against the alumina spheres. In the composite plating of this example, graphite is difficult to be roll-pressed because of small particle size thereof, when the graphite layer is not reliably formed. Further, since the scraped pieces of the graphite particles provide rollers, the other component is slid in a rolling contact, so that lubricity of graphite cannot be fully exhibited. Accordingly, wear resistance cannot be improved as compared to slide contact of FIG. 8.

As discussed above, wear resistance can be greatly improved when the graphite particle size is sufficiently great as to reliably form the graphite layer. Considering dispersibility and the like, the particle size of graphite is preferably 100 nm or greater and 500 nm or less.

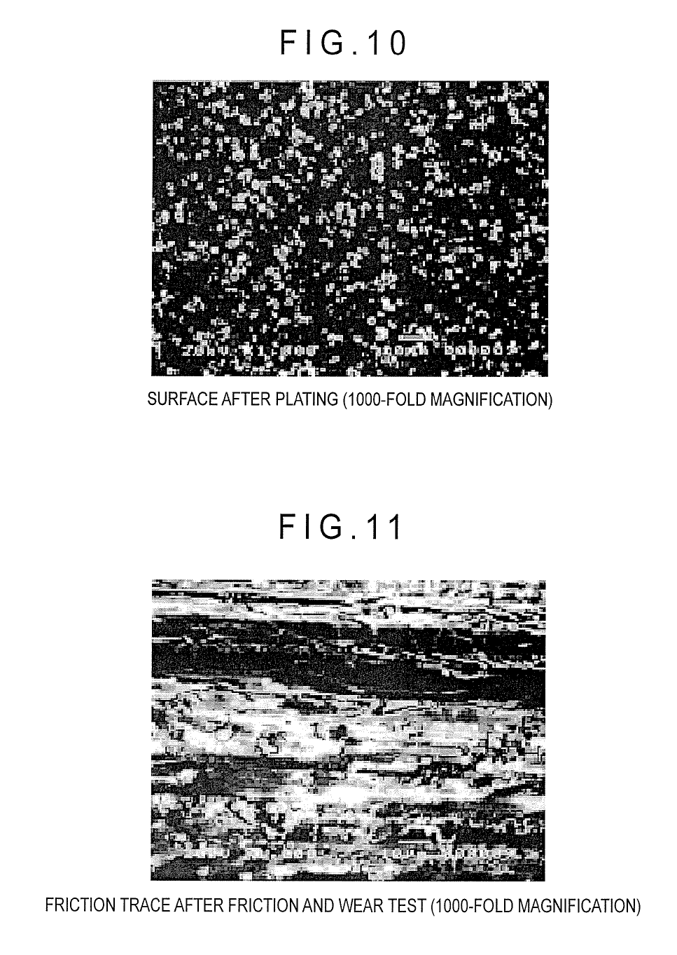

FIGS. 10 and 11 show enlarged photographs of surfaces of the test sample 2 at 1000-fold magnification after plating and after friction and wear test. As shown in FIG. 10, the graphite particles G were dispersed on the plated surface and a part of the graphite particles G was exposed from the coating. Further, as shown in FIG. 11, the graphite particles G were ground and expanded to be spread over the entire sample surface after the friction and wear test.

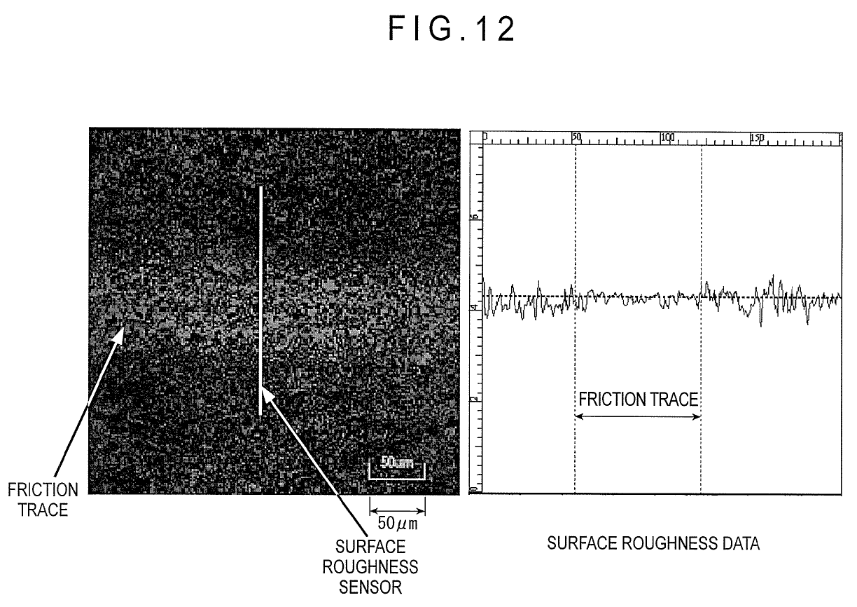

The left side of FIG. 12 is a photograph of a surface of the test sample 2 after the friction and wear test to highlight the worn portion (worn trace) against the other portion. The right side of FIG. 12 shows the measurement results of surface roughness measured in a direction orthogonal to the direction of the worn trace. From these, it can be recognized that the friction and wear test ground and expanded the graphite particles G projected from the surface of the test sample 2 to smooth the surface. Roughness Ra of the worn trace was 0.06 μm and Roughness Ra of a portion other than the worn trace was 0.17 μm (measured by a wide view area confocal microscope HD 100D manufactured by Lasertec Corporation).

### 5. Effect of Embodiment

According to the exemplary embodiment, following effects are provided.

(1) The composite plating 160 provided on the rotor 121 contains the graphite particles G exposed from the nickel plating N. The slide motion of the rotor 121 against the jewel 150 results in roll-pressing the graphite particles G over the surface of the nickel plating N to provide the layer-shaped graphite-exposed portion 162. Accordingly, lubricity of graphite can be sufficiently exhibited under slide contact.

Further, since the graphite-exposed portion 162 is roll-pressed to be adhered on the coating 161, the layer-shaped graphite-exposed portion 162 can be maintained for a long time.

In addition, the composite plating 160 can be easily produced merely by conducting electroplating process after mixing the graphite particles G in a plating bath. Thus, the wear resistance of the rotor 121 that is especially easily worn after a high-speed sliding can be greatly improved at a low cost.

(2) Since the size of the graphite particles G is 100 nm or greater and 500 nm or less, the graphite particles are roll-pressed without being scraped when being slid against the other component, the layer-shaped graphite-exposed portion 162 formed by a continuous series of plurality of graphite particles G can be more reliably formed. Further, since the above particle size range ensures excellent dispersibility, the incorporated amount of the graphite particles G into the nickel plating N, i.e. the content of graphite, can be increased. Thus, the amount of the graphite particles G in the graphite-exposed portion 162 can be increased, thus improving lubricity. In sum, the wear resistance can be further improved on account of the graphite particles G that are roll-pressed without being scraped and the increase in the content by ensuring excellent dispersibility.

(3) Since the size of the graphite particles G is sufficiently large as described above, the incorporated amount of the graphite particles G can be increased, thus allowing the thickness of the composite plating 160 to be as thin as 0.1 μm or more and 10 μm or less. Accordingly, variation in film thickness of the composite plating 160 can be reduced, so that sufficient dimension accuracy required for timepiece component can be obtained.

(4) Since the size of the graphite particles G is large as described above, the content of the graphite particles G in the nickel plating N can be increased as, for instance, 0.1 mass % or more and 5 mass % or less, so that lubricity can be improved.

(5) Since the composite plating 160 is provided not only on the lower pivot 124 and the upper pivot 125 but also on the entire surface of the rotor 121, a rotor 121 having excellent wear resistance and beautiful nickel plating N can be easily obtained. In other words, in order to provide decorative effect on the rotor 121, it is not necessary to provide separate plating processing on the portions other than the pivots or peel off the plating on the portions other than the pivots after once coating the entirety of the rotor 121 with composite plating.

### Second Embodiment

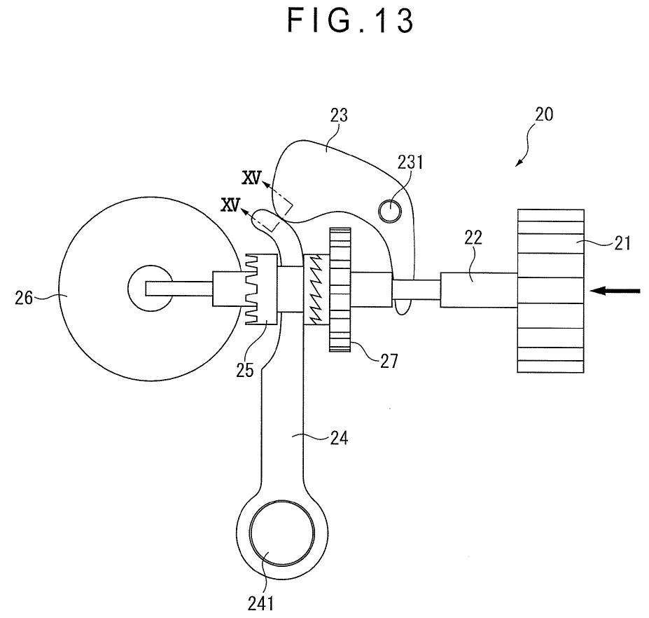

Next, a second exemplary embodiment of the invention will be described below with reference to FIGS. 13 to 15. In this exemplary embodiment, a trigger piece and a yoke having a switching part are shown as contact components provided with the composite plating.

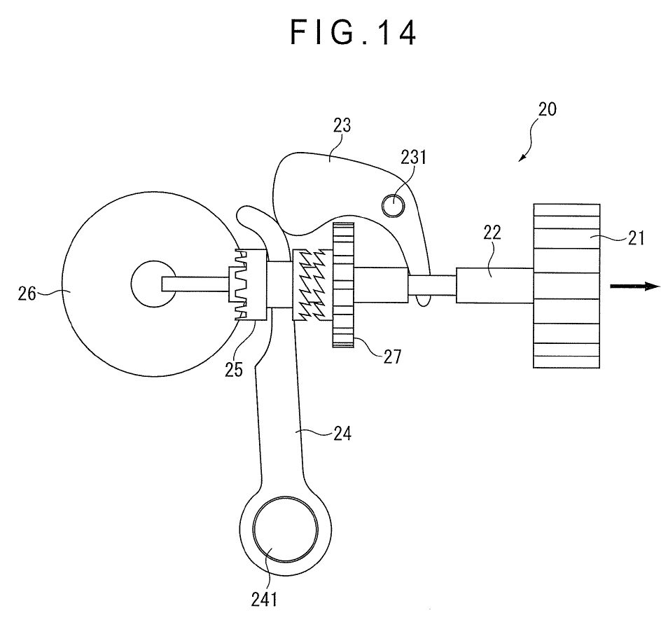

FIGS. 13 and 14 show a hand adjustment mechanism 20 installed in mechanical timepieces, electronic timepieces and electronically controlled timepieces. Incidentally, FIGS. 13 and 14 are viewed from a side of a windshield glass of a timepiece.

The hand adjustment mechanism 20 includes: a winding crown 21; a winding shaft 22; a trigger piece 23 and a yoke 24 that switch mutual contact state in accordance with winding operation on the winding shaft 22; a clutch wheel 25 having a square hole into which the winding shaft 22 is inserted; and an intermediate wheel 26 meshed with a minute wheel (not shown). Incidentally, a crown wheel 27 may be provided on a mechanical timepiece and an electronically controlled mechanical timepiece respectively having a power spring, where the power spring is wound up by turning the winding shaft 22 while the clutch wheel 25 is engaged with the crown wheel 27 as shown in FIG. 13.

Here, FIG. 13 shows the winding shaft 22 being pushed toward the interior of the movement, while FIG. 14 shows the winding shaft 22 being pulled out to the exterior of the movement.

The trigger piece 23 is rotatably provided on a trigger-piece pin 231 erected on a base plate and is engaged to a small-diameter section of the winding shaft 22. The trigger piece 23 is turned by axially pushing and pulling the winding shaft 22.

The yoke 24 is rotatably provided on a pin 241 erected on the base plate and is engaged to a small-diameter section of the clutch wheel 25. The yoke 24 is biased clockwise in FIG. 13 by a spring force of a yoke stopper (not shown) to contact with a side face of the trigger piece 23. The clutch wheel 25 engaged with the yoke 24 is spaced apart from the intermediate wheel 26 in FIG. 13. However, when the winding shaft 22 is pulled out as shown in FIG. 14, the trigger piece 23 is rotated to push the yoke 24 against the spring force of the yoke stopper to engage the clutch wheel 25 with the intermediate wheel 26. When the winding shaft 22 is rotated in this condition, the trigger piece 23, the yoke 24, the clutch wheel 25, the intermediate wheel 26, the minute wheel (not shown), an hour wheel (not shown) and a wheel and pinion (not shown) are sequentially rotated to allow a hand adjustment (display time correction).

The contact state between the yoke 24 and the trigger piece 23 is switched between the states of FIG. 13 and the state of FIG. 14. The switching part is provided by the side faces of the trigger piece 23 and the yoke 24. The side face of the trigger piece 23 and the side face of the yoke 24 touch with each other in the states shown in FIGS. 13 and 14 while being pressurized by the spring force of the yoke stopper (not shown). The pressurized contact determines the turning position of the trigger piece 23, so that the winding shaft 22 is kept being pressed inward or being pulled out.

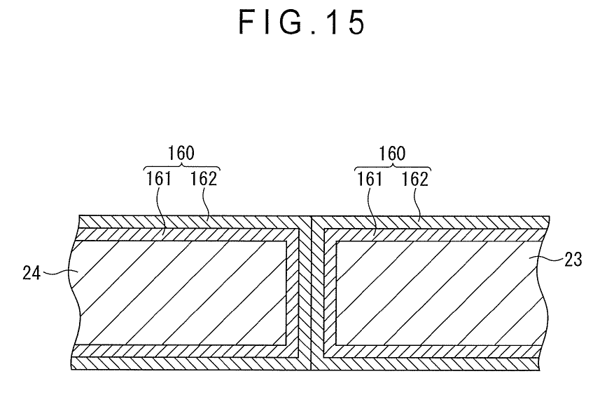

FIG. 15 is a cross section taken along XV-XV line in FIG. 13. The trigger piece 23 and the yoke 24 are likely to be worn on account of large load applied each time the contact state is switched. The same composite plating 160 as that of the first exemplary embodiment is provided respectively on the entire surface of the trigger piece 23 and the yoke 24. However, the composite plating 160 may be provided solely on the side faces of the trigger piece 23 and the yoke 24. Incidentally, FIG. 15 exaggerates the thickness of the coating 161 and the graphite-exposed portion 162.

The graphite-exposed portion 162 of the composite plating 160 is roll-pressed as shown in FIG. 5 as a result of switching of the contact state of the trigger piece 23 and the yoke 24. Since the trigger piece 23 slides against the yoke 24 on the intervening graphite-exposed portion 162 that is roll-pressed to assume a layer structure, wear resistance of the trigger piece 23 and the yoke 24 can be considerably improved.

According to this exemplary embodiment, the same effects as that mentioned in the first exemplary embodiment can be obtained.

Incidentally, since the composite plating 160 is provided on both the trigger piece 23 and the yoke 24, the wear resistance can be improved as compared with an arrangement in which the composite plating 160 is provided on only one of the trigger piece 23 and the yoke 24.

### Modifications of Embodiment

The invention is not limited to the foregoing embodiments but can be modified and improved within the scope of the invention.

For instance, though the composite plating 160 of the foregoing embodiments is provided by electroplating process, the composite plating may be imparted by an electroless plating process. Specifically, the composite plating containing graphite particles may be imparted by an electroless plating process using an electroless nickel plating bath instead of an electroplating nickel bath in the first and the second exemplary embodiments. According to the electroless plating process, a coating of a uniform thickness can be easily formed on irregular parts of contact components having large curvature such as pivots and pinions. Thus, high wear resistance can be stably obtained.

Incidentally, it is only required that the metal plating of the composite plating of the invention at least contains graphite particles, the composite plating of the invention may be provided by mixing the graphite particles and additional particles in the metal plating.

The composite plating of the invention may be provided on a part other than the rotor 121 of the generator as mentioned in the first exemplary embodiment or the trigger piece 23 and the yoke 24 as mentioned in the second exemplary embodiment.

For instance, the composite plating may be imparted on a rotor (contact piece having a sliding part) of a step motor for driving the hand. The composite plating may be formed not only on the rotor but also on a pivot and a pinion of a rotor pinion, and a pivot and a pinion of a timepiece gear train component such as a second wheel and pinion and third wheel and pinion. Further, the composite plating may be formed on a trigger-piece pin, a rotary shaft of a lever, a pin slidably guided by an elongated hole, and an operation shaft and a guide cylinder of a push button.

The hand adjustment mechanism is not limited to the hand adjustment mechanism 20 shown in the second exemplary embodiment but may be modified in various ways, which may be provided with a yoke stopper engaged with a clutch wheel and a reset lever that detects a pullout operation of the winding shaft to stop drive of hand. The composite plating may be formed on the portion at which the components constituting the hand adjustment mechanism are relatively slid or the contact state is switched.

Alternatively, the composite plating may be suitably formed on any sliding part that is contacted with the other component and is slid thereagainst and any switching part that switches a contact state against the other component.

What is claimed is:

1. A contact component, comprising:
a sliding part that contacts with an other component and slides on the other component; and
a switching part at which a contact state with the other component is switched, wherein
a composite plating including a metal plating and at least graphite particles is formed on the sliding part or the switching part.

2. The contact component according to claim 1, wherein
the composite plating includes a coating including a metal plating and a part of the graphite particles that is buried in the metal plating; and a graphite-exposed portion including a part of the graphite particles that is exposed from the coating, and
the graphite-exposed portion is rolled along the coating.

3. The contact component according to claim 1, wherein
the composite plating includes a coating including a metal plating and a part of the graphite particles that is buried in the metal plating; and a graphite-exposed portion including a part of the graphite particles that is exposed from the coating, and
he graphite-exposed portion is rolled along the coating when being contacted with the other component.

4. The contact component according to claim 1, wherein
the particle size of the graphite particles is 100 nm or greater and 500 nm or smaller.

5. The contact component according to claim 1, wherein
the thickness of the composite plating is 0.1 μm or more and 10 μm or less.

6. The contact component according to claim 1, wherein
the content of the graphite particles in the metal plating is 0.1 mass % or more and 5 mass % or less.

7. The contact component according to claim 1, wherein
the composite plating is formed on an entire surface of the contact component or on a contact portion against the other component.

8. The contact component according to claim 1, wherein
the metal plating is nickel plating.

9. The contact component according to claim 1, wherein
the composite plating is formed by electroplating process.

10. The contact component according to claim 1, wherein
the composite plating is formed by electroless plating process.

11. The contact component according to claim 1, wherein
the sliding part is a pivot of a timepiece gear train component or a pinion of a timepiece gear train component.

12. The contact component according to claim 1, wherein
the switching part contacts the other component while being pressed by a spring force.

13. A timepiece comprising: the contact component according to claim 1.
